(19) United States
(12) Patent Application Publication
(10) Pub. No.: US 2006/0156258 A1
(43) Pub. Date: Jul. 13, 2006

(54) Display apparatuses and methods for automatically entering factory configuration mode

(75) Inventor: Cheng-Chieh Liu, Taoyuan County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/329,254

(22) Filed: Jan. 11, 2006

(30) Foreign Application Priority Data
Jan. 12, 2005 (TW) 94100828

(51) Int. Cl. G06F 17/00

(52) U.S. Cl. 715/866

(57) ABSTRACT

A method for automatically entering factory configuration mode. An input signal is received. Frequency of the input signal falling within a predetermined range is determined. When frequency of the input signal falls within a predetermined range, a factory mode OSD (on-screen display) is activated.

### BACKGROUND

The present invention relates to display apparatuses, and more particularly, to display apparatuses capable of automatically entering factory configuration mode.

Two types of OSDs (on-screen display), user mode and factory mode, are typically used to change configurations of display apparatuses, to adjust brightness, contrast and chromaticity. A factory mode OSD provides more configuration options for factory operators than a user mode OSD. Conventionally, user mode and factory mode OSDs are activated and operated via front panel buttons of display apparatuses. FIG. 1 is a diagram showing front panel buttons of a display apparatus, including a power switch 19, and buttons 11, 13, 15 and 17. For example, when button 11 is depressed, user mode OSD is activated, and otherwise, when signals from buttons 11, 13 and 15 are simultaneously detected, factory mode OSD is activated. Factory mode OSD, however, may be activated by users.

### SUMMARY

Methods for automatically entering factory configuration mode are provided. An exemplary method receives an input signal, determines whether frequency of the input signal falls within a predetermined range, and when frequency of the input signal falls within the predetermined range, a factory mode OSD (on-screen display) is activated.

A machine-readable storage medium storing a computer program which, when executed, performs the method for automatically entering factory configuration mode is also disclosed.

Display apparatuses capable of automatically entering factory configuration mode are provided. An exemplary embodiment of a display apparatus comprises a scalar IC. The scalar. IC receives an input signal, determines whether frequency of the input signal falls within a predetermined range, and when frequency of the input signal falls within the predetermined range, a factory mode OSD (on-screen display) is activated.

### DESCRIPTION OF THE DRAWINGS

Display apparatuses and methods capable of automatically entering factory configuration mode will become more fully understood by referring to the following detailed description of embodiments with reference to the accompanying drawings, wherein:

FIG. 1 is a diagram showing front panel buttons of a display apparatus;

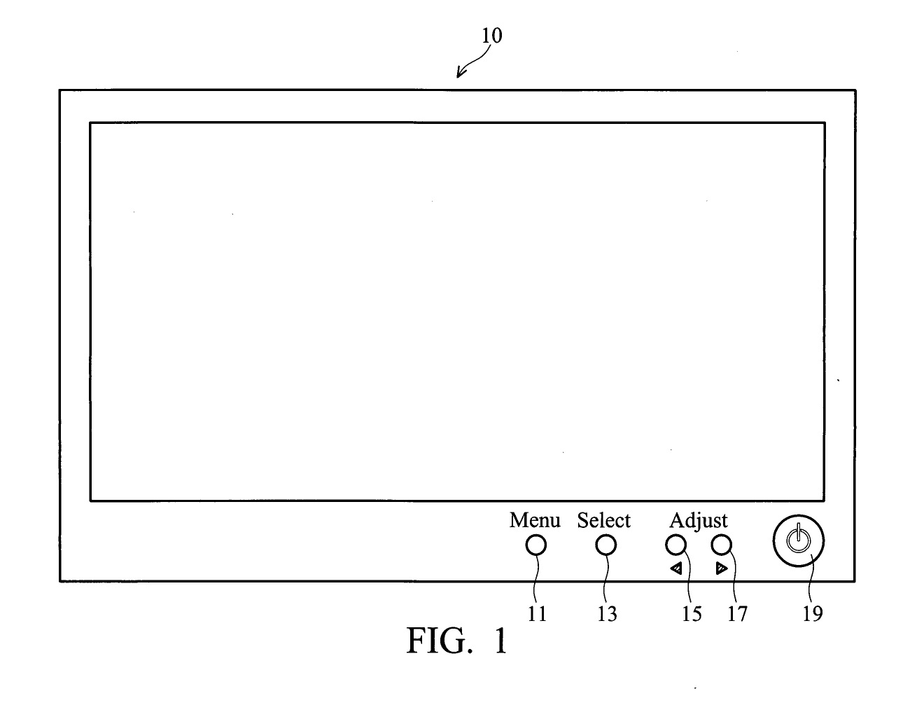

FIG. 2 is a diagram of system architecture of an embodiment of LCD (Liquid Crystal Display) apparatuses;

FIG. 3 is a screen diagram of an exemplary user mode OSD (on-screen display);

FIGS. 4a and 4b are screen diagrams of an exemplary factory mode OSD;

FIG. 5 is a flowchart of an embodiment of methods for automatically entering factory configuration mode;

FIG. 6 is a diagram illustrating pseudo-codes providing an embodiment of a method for automatically entering factory configuration mode.

### DETAILED DESCRIPTION

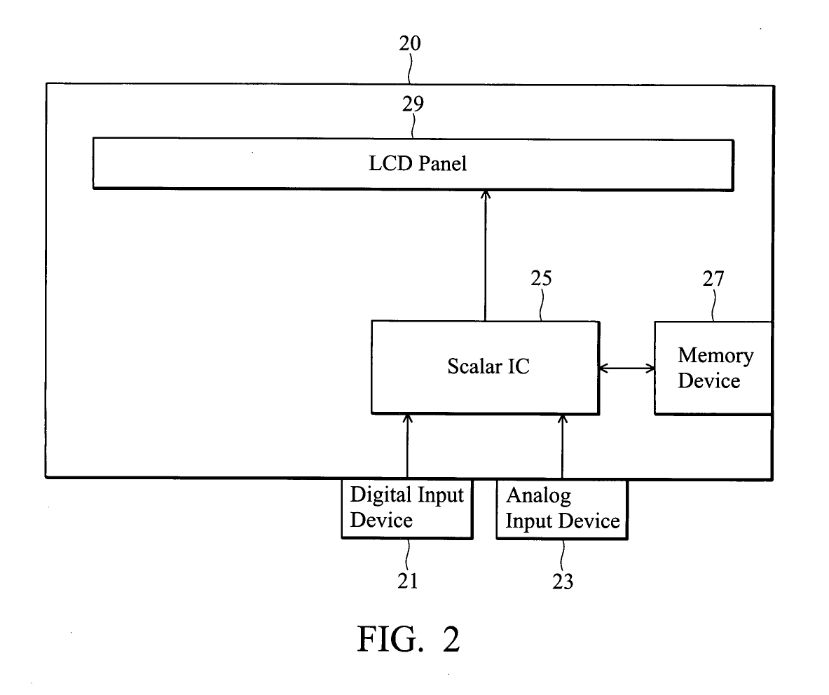

FIG. 2 is a diagram of system architecture of an embodiment of LCD (Liquid Crystal Display) apparatuses. A LCD apparatus 20 comprises a digital input device 21, an analog input device 23, a scalar IC 25, a memory device 27 and a LCD panel 29. Moreover, those skilled in the art will understand that some embodiments may be practiced with other display configurations, including CRT (Cathode Ray Tube), PDP (Plasma Display Panel), OLED (Organic Light-Emitting Diode) displays, and the like. The memory device 27, such as random access memory (RAM), read-only memory (ROM), flash ROM, and the like, stores program modules executed by the scalar IC 25 to perform factory mode OSD activation. The scalar IC 25 receives R, G, B, Hsync and Vsync signals via the digital input device 21 or analog input device 23, and accordingly controls the LCD panel to display specific pictures. R, G, B signals provide color information for all pixels in a picture, and Hsync and Vsync signals provide resolution information such as 1024×768, 1960×1280 and the like, for a picture.

The scalar IC 25 detects input signals, preferably Hsync or Vsync signals, and when frequency of one input signal is determined to fall within a predetermined range, for example, 190 to 200 KHz, a factory mode flag is enabled to activate a factory mode OSD. The input signals can be received from PCs or video pattern generators such as Chroma 2225, Chroma 2213 (Chroma cooperation of Taiwan), and the like.

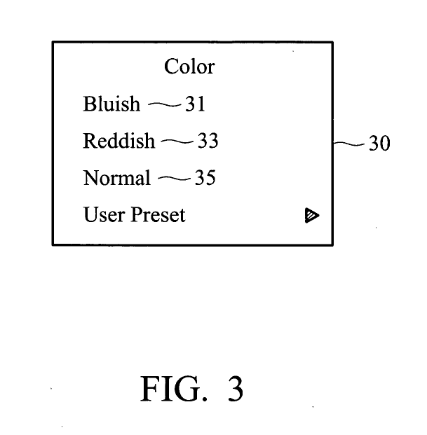

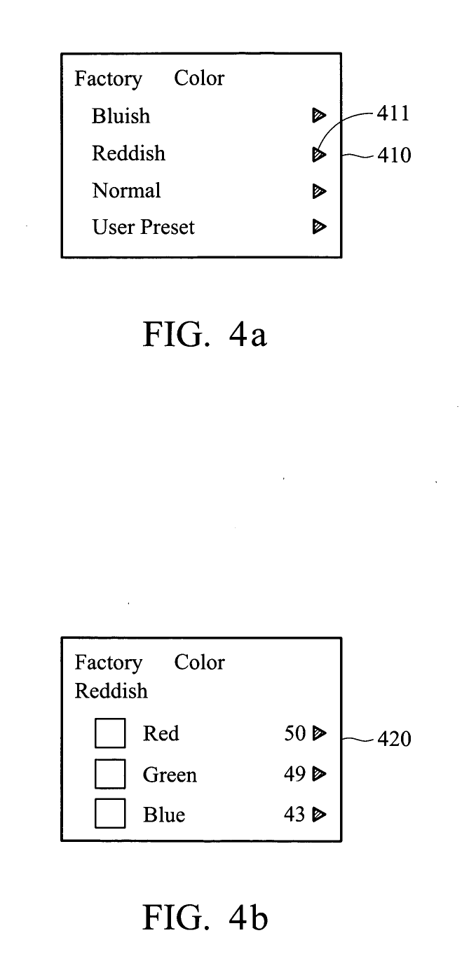

FIG. 3 is a screen diagram of an exemplary user mode OSD. Selection items 31 and 33 on an user mode OSD 30 instruct users to adjust display parameters of bluish or reddish. FIGS. 4a and 4b are screen diagrams of an exemplary factory mode OSD. A factory mode OSD 410 provides more options than the user mode OSD 30, for example, an entry point 411 on the factory mode OSD 410 of FIG. 4a can be selected to further configure reddish specifications. When entry point 411 is selected, a factory mode OSD 420 of FIG. 4b is displayed to facilitate configuration of reddish specifications. Noted that the user mode OSD 30 does not provide any entry point to enter the factory user mode OSD 420 of FIG. 4b.

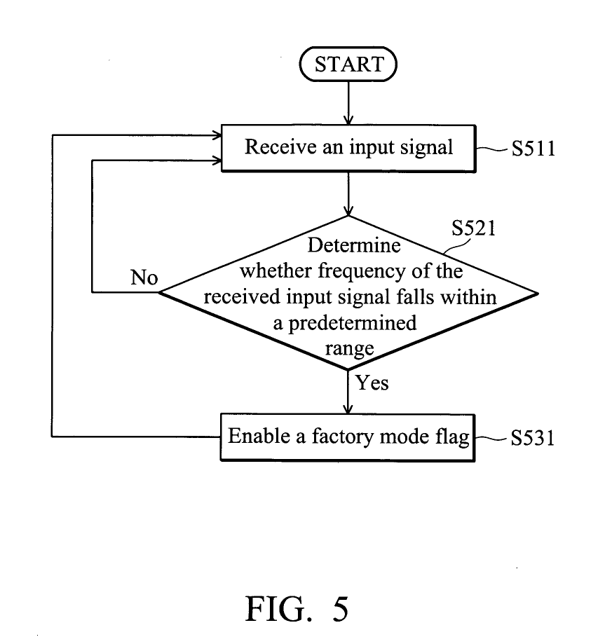

FIG. 5 is a flowchart of an embodiment of methods for automatically entering factory configuration mode. The process begins in step S511, receiving an input signal, preferably Hsync or Vsync signal. In step S521, it is determined whether frequency of the received input signal falls within a predetermined range, for example, 190 to 200 KHz. If so, the process proceeds to step S531, and otherwise, proceeds to step S511. In step S531, a factory mode flag is enabled to activate a factory mode OSD.

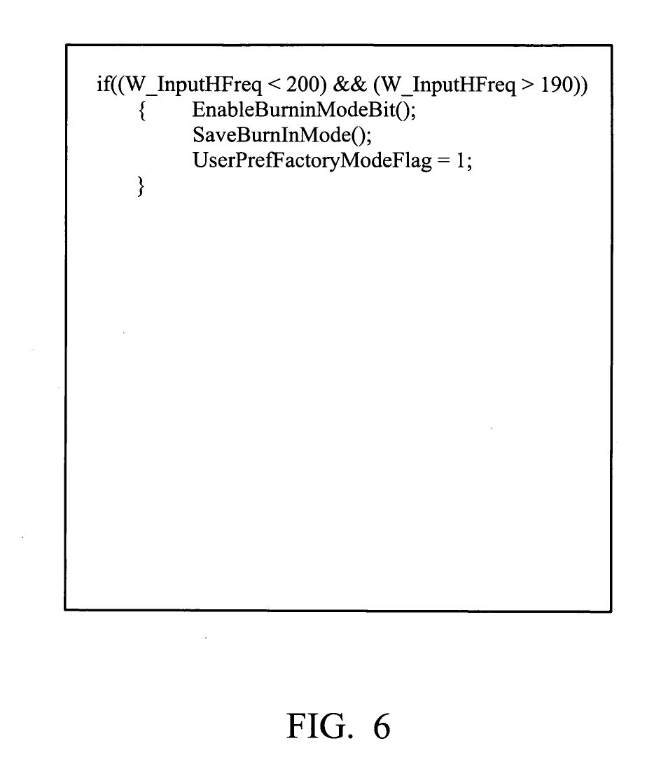

Also disclosed is a storage medium as shown in FIG. 6 storing pseudo-codes providing the disclosed methods for automatically entering factory configuration mode, wherein variable “W_InputHfreq” represents frequency of Hsync signal and variable “UserPrefFactoryModelFlag” represents a factory mode flag.

While the invention has been described in terms of preferred embodiment, it is not intended to limit the invention thereto. Those skilled in this technology can still make various alterations and modifications without departing from the scope and spirit of this invention. Therefore, the scope of the invention shall be defined and protected by the following claims and their equivalents.

What is claimed is:

1. A method for automatically entering factory configuration mode, loaded and executed by a display apparatus, the method comprising:
receiving an input signal;
determining whether frequency of the input signal falls within a predetermined range; and
activating a factory mode OSD (on-screen display) when the frequency of the input signal falls within the predetermined range.

2. The method as claimed in claim 1 wherein the display apparatus is an LCD (Liquid Crystal Display), CRT (Cathode Ray Tube), PDP (Plasma Display Panel) or OLED (Organic Light-Emitting Diode) apparatus.

3. The method as claimed in claim 1 wherein the input signal is Hsync or Vsync signal.

4. The method as claimed in claim 1 further comprising enabling a factory mode flag to activate the factory mode OSD.

5. The method as claimed in claim 1 wherein the factory mode OSD provides more options to configure the display apparatus than a user mode OSD.

6. A machine-readable storage medium storing a computer program which, when executed, performs a method for automatically entering factory configuration mode by a display apparatus, the method comprising:
receiving an input signal;
determining whether frequency of the input signal falls within a predetermined range; and
activating a factory mode OSD (on-screen display) when the frequency of the input signal falls within the predetermined range.

7. The machine-readable storage medium as claimed in claim 6 wherein the display apparatus is a LCD (Liquid Crystal Display), CRT (Cathode Ray Tube), PDP (Plasma Display Panel) or OLED (Organic Light-Emitting Diode) apparatus.

8. A display apparatus capable of automatically entering factory configuration mode, comprising a scalar IC receiving an input signal, determining whether frequency of the input signal falls within a predetermined range, and when the frequency of the input signal falls within the predetermined range, activating a factory mode OSD (on-screen display).

9. The display apparatus as claimed in claim 8 wherein the display apparatus is a LCD (Liquid Crystal Display), CRT (Cathode Ray Tube), PDP (Plasma Display Panel) or OLED (Organic Light-Emitting Diode) apparatus.

10. The display apparatus as claimed in claim 8 wherein the input signal is Hsync or Vsync signal.

11. The display apparatus as claimed in claim 8 wherein the scalar IC enables a factory mode flag to activate the factory mode OSD.

12. The display apparatus as claimed in claim 8 wherein the factory mode OSD provides more options to configure the display apparatus than a user mode OSD.
